(19) United States
(12) Patent Application Publication
(10) Pub. No.: US 2006/0109145 A1
(43) Pub. Date: May 25, 2006

(54) Electronic map and method for rapidly finding a geographic location of a landmark in the electronic map

(75) Inventor: Shu-Ching Chen, Changhua City (TW)

Correspondence Address: COOPER & DUNHAM, LLP, 1185 AVENUE OF THE AMERICAS, NEW YORK, NY, 10036, US

(73) Assignee: Taiwan Online Co., Ltd.

(21) Appl. No.: 11/312,309

(22) Filed: Dec. 20, 2005

Related U.S. Application Data
(63) Continuation-in-part of application No. 10/287,389, filed on Nov. 4, 2002.
Application No. 10/287,389 is a continuation-in-part of application No. 09/905,396, filed on Jul. 13, 2001, now Pat. No. 6,938,101.
Application No. 10/287,389 is a continuation-in-part of application No. 09/905,396, filed on Jul. 13, 2001, now Pat. No. 6,938,101.
(60) Provisional application No. 60/390,167, filed on Jun. 20, 2002.
(60) Provisional application No. 60/374,556, filed on Apr. 22, 2002.
(60) Provisional application No. 60/371,223, filed on Apr. 9, 2002.
(60) Provisional application No. 60/344,020, filed on Dec. 20, 2001.
(60) Provisional application No. 60/334,774, filed on Nov. 20, 2001.

(51) Int. Cl. G08G 1/123

(52) U.S. Cl. 340/995.24; 340/995.15

(57) ABSTRACT

An electronic map and a method for rapidly finding a geographic location of a landmark in the electronic map will automatically shift and center the electronic map on a selected landmark to provide user the clearest surrounding route as well as rapidly acquaint the user the neighbor geographic location of the landmark.

### BACKGROUND OF THE INVENTION

1. Field of the Invention

The present invention relates to an electronic map, and more particularly to an electronic map and a method for rapidly finding a geographic location of a landmark in the electronic map.

2. Description of Related Art

As the development of electronic technology, many people use a electronic maps to print out destinations before they travel, so an electronic map has been regarded as a useful tool for looking for certain locations nowadays. A conventional electronic map comprises multiple digital images converted from paper map images or drafted by computer programs. With increase of demands, electronic maps offer additional functions, such as to provide specific symbols to parts of the famous shop or scenic spots of historical significance in the map to make a user searching a specific locations easily and conveniently.

However, the use of a conventional electronic map is still inconvenient. Although the conventional electronic map provides a zoom in and out feature that allow a user to get main arteries by zooming-out the graphic map and detail geographic locations by zooming-in the graphic map, it is still difficult to find a specific location in a zooming-in map by shifting the map.

Furthermore, conventional electronic maps do not offer web information of businesses, so the conventional electronic maps are not versatile in use.

To overcome the shortcomings, the present invention provides an electronic map and a method for rapidly finding a geographic location of a landmark in the electronic map to obviate or mitigate the aforementioned problems.

### SUMMARY OF THE INVENTION

The main objective of the present invention is to provide an electronic map and a method for rapidly finding a geographic location of a landmark in the electronic map that enables user to find a specific landmark on the map more quickly by using zoom in and out feature and centers the electronic map on the selected landmark automatically that provides user the clearest surrounding route as well as makes the user rapidly find the geographic location of the landmark.

Another objective of the present invention is to provide an electronic map, wherein each landmark is identified by its own uniquely trademark or symbol that provides an aid to search and good readability of the electronic map.

Further objective of the present invention is to provide an electronic map that provides additional information about a specific landmark such like Address, TEL, FAX, Business Hours and/or URL in a pop-up window by clicking the landmark and enables user to access the landmark's web site by clicking the URL that appears in the window.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of an electronic map in accordance with the present invention showing a map display;

FIG. 2 is a schematic diagram of the electronic map in FIG. 1 showing an enlarged map display;

FIG. 3 is a schematic diagram of the electronic map in FIG. 2 showing a linking display of a Web Page of a selected location;

FIG. 4 is a schematic diagram of the electronic map in FIG. 1 showing a zooming-in map display;

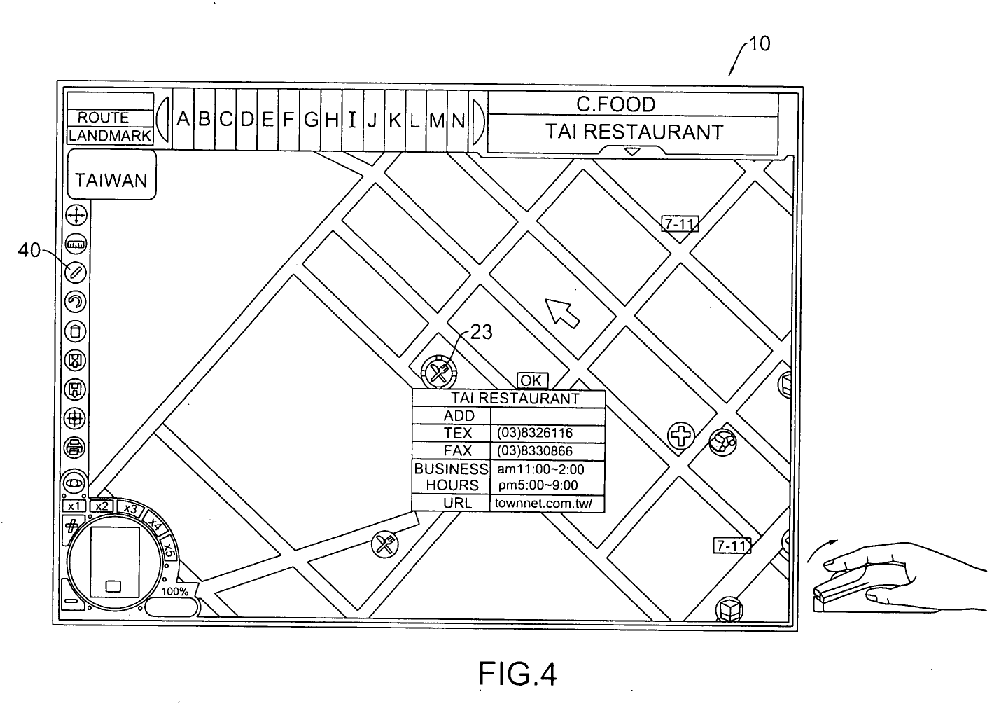

FIG. 5 is a schematic diagram of the electronic map in FIG. 1 showing a map display including the drawing feature; and

FIG. 6 is an operational schematic diagram of the electronic map in FIG. 1 showing a display of the drawing feature is actuated.

### DETAILED DESCRIPTION OF THE PREFERRED EMBODIMENT

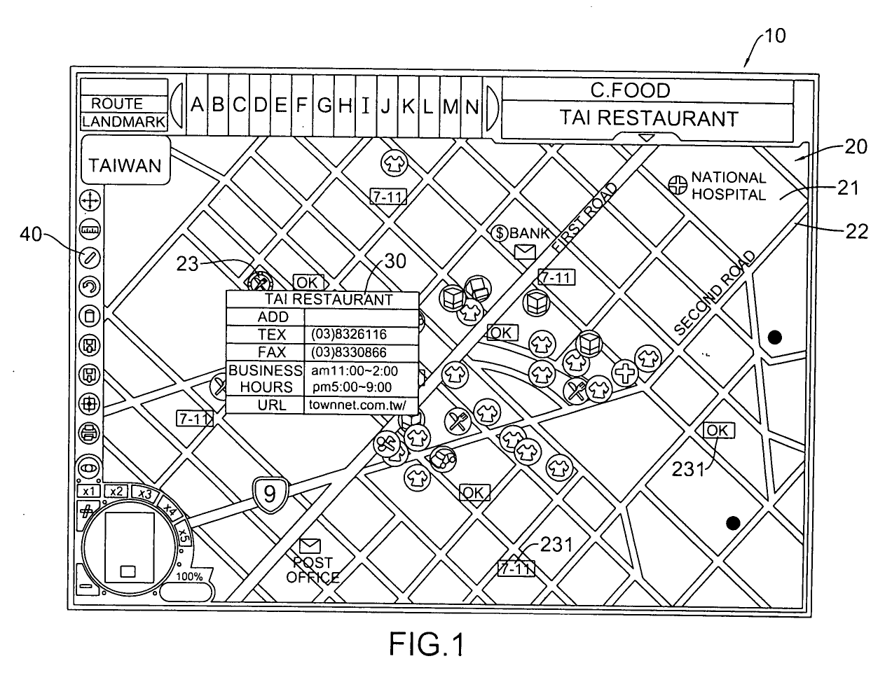

With reference to FIG. 1, an electrical map (10) in accordance with the present invention comprises multiple layers, symbolizing means, displaying means, resizing means, shifting means and informing means.

The multiple layers comprises landform layers, route layers and landmark layers according to the unifying feature of digital object attached to.

Each route layer has multiple graphic route objects.

Each landmark layer has multiple graphic landmark objects.

The symbolizing means for symbolizing the landform layers to digital map (21), the graphic route objects to digital route objects (22) and the graphic landmark objects to digital landmark objects (23) which are respectively identified by its own uniquely trademark or symbol like 7-11 (231).

The displaying means for establishing relative coordinate relationship of each digital route object (22) and each digital landmark object (23) on the digital map (21) and associating all layers to show a graphic map (20).

The resizing means for resizing the symbols of each digital landmark objects (23) to fit with a current scale of graphic map (20) to avoid parts of the graphic map (20) from being covered by the digital landmark object (23).

The shifting means for automatically shifting the graphic map (20) to make a selected digital landmark object (23) as a center of the graphic map (20).

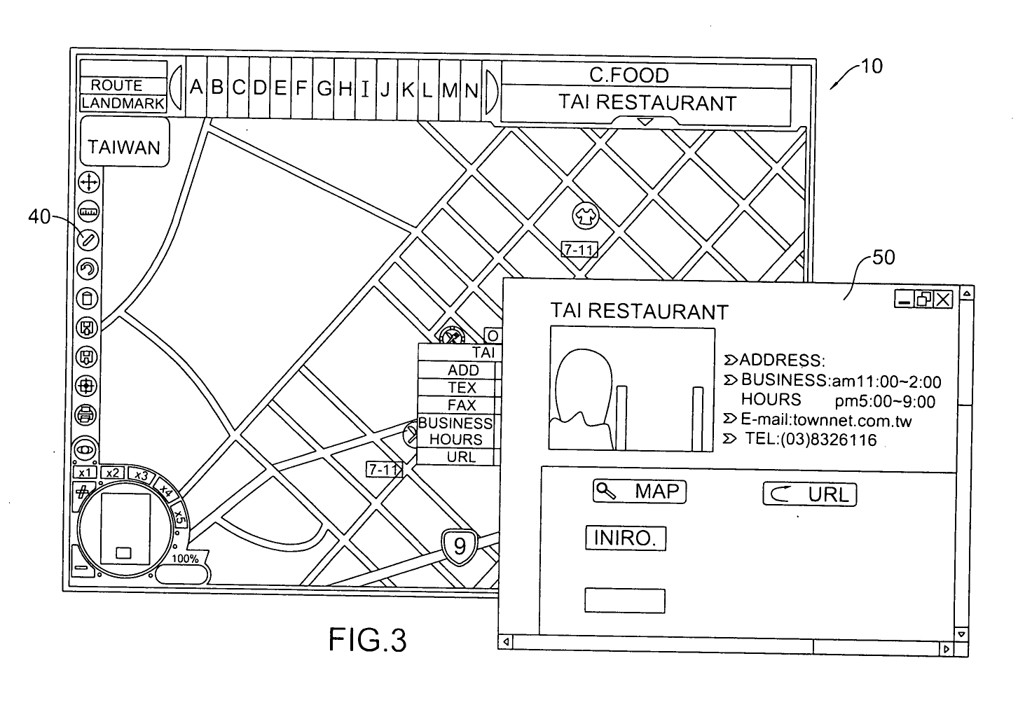

The informing means for providing real-time information of the selected digital landmark object (23), a digital landmark object (23) is pointed by the user, meanwhile some information of the selected digital landmark object (23) such as URL, TEL and an introduction are displayed, hat will shorten the searching time and increase the opportunity of consumption. With further reference to FIG. 3, a specific digital landmark object (23) is selected, a pop-up information window (30) will appear immediately with a variety of information like address, TEL, FAX and Business Hours for reference. The pop-up information window (30) may further comprise a URL—an HTML for the Web Page link, whereby user can view the Web Page of the landmark in a web browser by clicking the URL.

The method for rapidly finding a geographic location of a landmark in an electronic map and comprises the steps of (1) selecting a digital landmark object (23), (2) centering the graphic map (20) on the selected digital landmark object (23).

In the selecting a digital landmark object (23) step, each digital landmark objects (23) are respectively identified by its own uniquely trademark or symbol to speed up user's searching and then select a specific digital landmark objects (23).

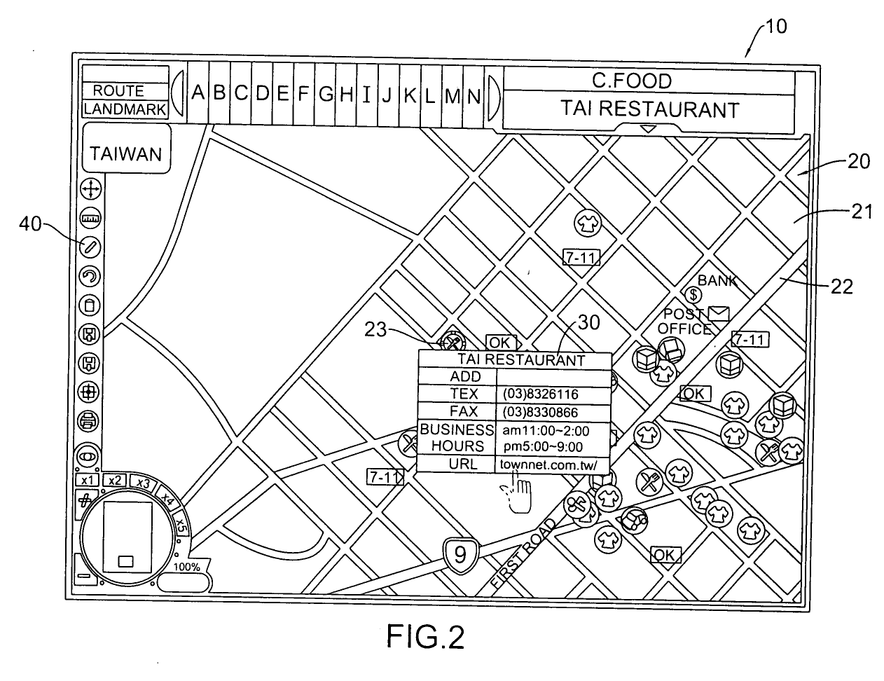

The step of centering the graphic map (20) comprises centering the graphic map (20) on the selected digital landmark object (23) and shifting the graphic map (20) around. With further reference to FIG. 2, the electronic map (10) is centered on the selected digital landmark object (23) to provide user a clearest surrounding route as well as rapidly acquainting the user the neighbor geographic location of the landmark.

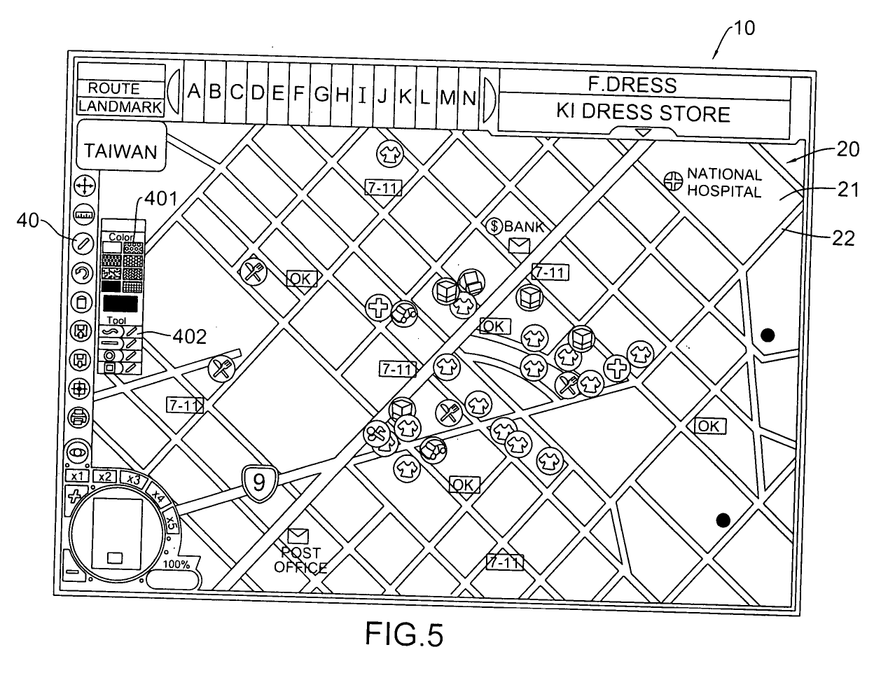

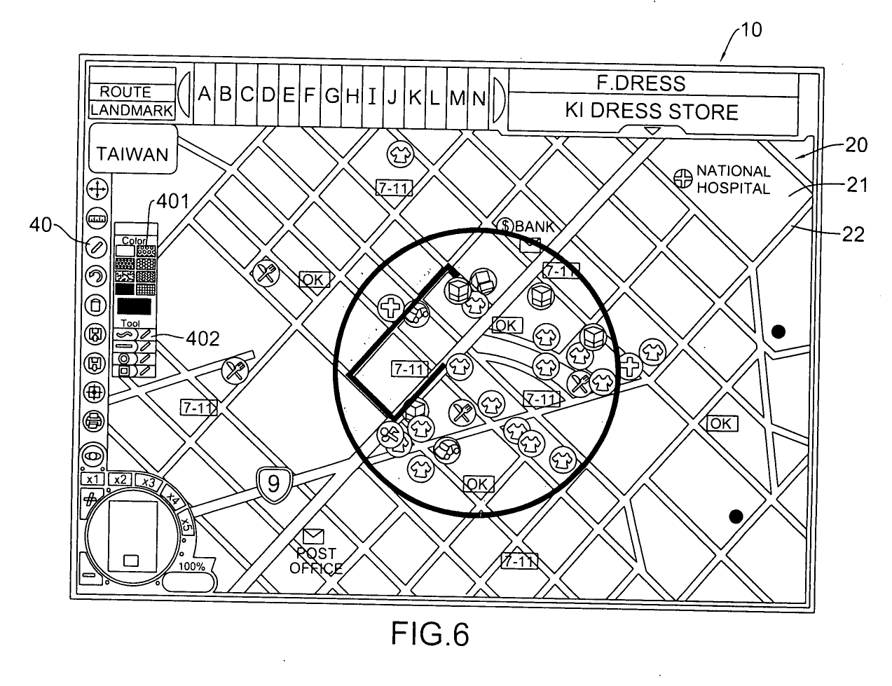

With reference to FIG. 5, the electronic map (10) further comprises a drawing means for drawing a graphic drawing on the graphic map (20), symbolizing the graphic drawing into digital drawing object, establishing relative coordinate relationship of the digital drawing object on the digital map (21) and then associate all layers to show a graphic map (20) with a drawing.

Whereby a real-time drawing feature (40) is provided and is actuated from the color menu (401) and the tool menu (402) that allow a user to select the desired color in color menu (401) and desired line shape in tool menu (402), then draw a drawing on the graphic map (20), as shown in FIG. 6. The movement of the drawing and the size of the drawing will be resized by the resizing means to fit with a current scale of graphic map (20).

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. In an electronic map comprising symbolizing means for symbolizing objects on a graphic map into digital landmark objects and digital route objects;
displaying means for establishing relative coordinate relationship between the digital landmark objects and the digital route objects on the graphic map; and
shifting means for automatically shifting the graphic map to make a selected digital landmark object as a center of the graphic map.

2. The electronic map as claimed in claim 1 further comprises
informing means for providing real-time information of the selected digital landmark object.

3. The method as claimed in claim 2, wherein the real-time information has a pop-up information window and comprises information of at least one of Address, TEL, FAX, Business Hours and URL.

4. The electronic map as claimed in claim 3 further comprises drawing means for draw a graphic drawing on the graphic map.

5. The electronic map as claimed in claim 4, wherein
the drawing means comprises a color menu for a user selecting a desired color in color menu and a tool menu for the user selecting a desired line shape in tool menu.

6. A method for rapidly finding a geographic location of a landmark in the electronic map in claim 1 and comprising steps of
symbolizing objects on a graphic map into digital landmark objects and establishing relative coordinate relationship between the digital landmark objects and digital route objects;
selecting one of the digital landmark objects on the graphic map;
shifting the graphic map to make a selected digital landmark object as a center of the graphic map.

7. The method as claimed in claim 6, wherein the centering the graphic map on the selected digital landmark object step comprises centering the graphic map on the selected digital landmark object and shifting the graphic map around to make a user rapidly find the neighbor geographic location of the landmark.
